(19) United States
(12) Patent Application Publication
(10) Pub. No.: US 2024/0084781 A1
(43) Pub. Date: Mar. 14, 2024

(54) WIND-TURBINE TOWER FACILITY AND METHOD OF ASSEMBLING SAME

(71) Applicant: Vestas Wind Systems A/S, Aarhus N (DK)

(72) Inventors: Hideyasu Fujioka, Aarhus N (DK); Peter Sigfred Mortensen, Risskov (DK)

(21) Appl. No.: 17/766,868

(22) PCT Filed: Oct. 22, 2020
(86) PCT No.: PCT/EP2020/079796

§ 371 Date: Apr. 6, 2022

(30) Foreign Application Priority Data
Oct. 25, 2019 (EP) 19205375.9

(51) Int. Cl. F03D 13/25

(52) U.S. Cl. CPC F03D 13/25; F05B 2240/95; F05B 2260/301

(57) ABSTRACT

A wind-turbine tower facility includes a monopile, a transition piece foundation, and a tower disposed on top of the foundation. The tower includes a first cylindrical part and a first outer flange protruding from a lower end of the first cylindrical part toward an outer side of the tower. The foundation includes a second cylindrical part and a second outer flange protruding from an upper end of the second cylindrical part toward an outer side of the foundation. The tower and the foundation are connected by a plurality of stud bolts passing through the first outer flange and the second outer flange. Below the second outer flange, a protruding part is protruding from the second cylindrical part to under the second outer flange.

### TECHNICAL FIELD

This disclosure relates to a wind-turbine tower facility, such as an offshore wind-turbine facility and a method of assembling the same.

### BACKGROUND ART

Patent Document 1 discloses that two tower sections are provided with inner flanges that protrude inward, and the tower sections are connected by securing these inner flanges with a bolt. Patent Document 2 discloses a wind turbine including a platform used for maintenance of devices.

### CITATION LIST

### Patent Literature

Patent Document 1: EP2192245A
Patent Document 2: WO2013/060703A

### SUMMARY

In recent years, wind turbines installed on the waterside such as lakes, seas, and rivers to generate wind power have become common. Such wind turbines (e.g., bottom-fixed offshore wind turbine) mostly include a foundation such as a monopile with a transition piece, and a tower as a wind-turbine tower facility.

This wind turbine needs strong connection between the tower and the foundation to provide strength against earthquakes, waves, or high winds. In this regard, the configuration which secures the inner flanges as disclosed in Patent Document 1 may not provide a sufficient connection strength. It is thus conceivable to provide outer flanges that protrude outward to the tower and the foundation optionally including the transition piece and secure them.

Since the transition piece is placed in a position affected by waves, the transition piece is designed to be stiffer than the tower. Therefore, the protruding part particularly if the protruding part is a platform, is generally provided on the outer periphery of the transition piece having high stiffness. However, in the case where outer flanges are provided to the tower and the foundation including transition piece, it was found that the protruding part needs to be placed in an appropriate position away from the outer flanges. Patent Documents 1 and 2 do not disclose measures for achieving such appropriate placement.

In view of the above, an object of the present disclosure is to provide a wind-turbine tower facility that can more firmly connect the tower to the foundation (optionally including the transition piece) and can place the protruding part such as a platform in an appropriate position.

A wind-turbine tower facility according to the present disclosure includes: a foundation (such as a monopile with a transition piece disposed on top of the monopile); and a tower disposed on top of the foundation. The tower includes a first cylindrical part and a first outer flange protruding from a lower end of the first cylindrical part toward an outer side of the tower. The foundation includes a second cylindrical part and a second outer flange protruding from an upper end of the second cylindrical part toward an outer side of the foundation. The tower and foundation are connected by a plurality of bolts passing through the first outer flange and the second outer flange. Below the second outer flange, a protruding part, (such as a platform) is protruding from the second cylindrical part to under the second outer flange. Furthermore, the plurality of bolts are stud bolts.

One aspect of the wind turbine tower facility of the invention concerns a wind-turbine tower facility according to the present disclosure includes: a monopile; a transition piece disposed on top of the monopile; and a tower disposed on top of the transition piece. The tower includes a first cylindrical part and a first outer flange protruding from a lower end of the first cylindrical part toward an outer side of the tower. The transition piece includes a second cylindrical part and a second outer flange protruding from an upper end of the second cylindrical part toward an outer side of the transition piece. The tower and the transition piece are connected by a plurality of stud bolts passing through the first outer flange and the second outer flange. A platform is disposed, below the second outer flange, on an outer periphery of the transition piece.

A method of assembling a wind-turbine tower facility according to the present disclosure includes: disposing a foundation (such as a monopile with a transition piece on top) in water; disposing a tower on top of the foundation; and inserting a plurality of bolt so as to pass through a first outer flange protruding from a lower end of a first cylindrical part of the tower toward an outer side of the tower and a second outer flange protruding from an upper end of a second cylindrical part of the foundation toward an outer side of the foundation to connect the tower and the foundation by the plurality of bolts. Below the second outer flange, a protruding part (such as a platform) is protruding from the second cylindrical part to under the second outer flange part. Furthermore, the plurality of bolts are stud bolts.

One aspect of the method of the invention concerns a method of assembling a wind-turbine tower facility according to the present disclosure includes: disposing a monopile on bottom of water; disposing a transition piece on top of the monopile; disposing a tower on top of the transition piece; and inserting a plurality of stud bolts so as to pass through a first outer flange protruding from a lower end of a first cylindrical part of the tower toward an outer side of the tower and a second outer flange protruding from an upper end of a second cylindrical part of the transition piece toward an outer side of the transition piece to connect the tower and the transition piece by the plurality of stud bolts. A platform is disposed, below the second outer flange, on an outer periphery of the transition piece.

According to the present disclosure, there is provided a wind-turbine tower facility that can more firmly connect the tower to the transition piece and can place the platform in an appropriate position.

### BRIEF DESCRIPTION OF DRAWINGS

FIG. 1 is a schematic diagram for describing a configuration of a wind-turbine tower facility according to an embodiment.

FIG. 2A is a cross-sectional view of a connection portion between a tower and a transition piece according to an embodiment.

FIG. 2B is a cross-sectional view of a connection portion between a tower and a transition piece according to an embodiment.

FIG. 3 is a cross-sectional view of a cap provided on a wind-turbine tower facility according to an embodiment.

FIG. 4 is a cross-sectional view of a grease used for a wind-turbine tower facility according to an embodiment.

FIG. 5A is a front view of usage of an adjustment ring of a wind-turbine tower facility according to an embodiment.

FIG. 5B is a perspective view of an adjustment ring provided in a wind-turbine tower facility according to an embodiment.

FIG. 6A is a schematic diagram showing a state where a nut is temporarily fixed to a stud bolt according to an embodiment.

FIG. 6B is a schematic diagram showing a state where tension is applied to a stud bolt according to an embodiment.

FIG. 6C is a schematic diagram showing a state where a stud bolt is tightened according to an embodiment.

FIG. 7A is a schematic diagram for describing a state where a bolt tensioner device is about to be used according to an embodiment.

FIG. 7B is a schematic diagram for describing a state where a bolt tensioner is being used according to an embodiment.

FIG. 8 is a flowchart of a method of assembling a wind-turbine tower facility according to an embodiment.

### DETAILED DESCRIPTION

Embodiments will now be described in detail with reference to the accompanying drawings. It is intended, however, that unless particularly specified, dimensions, materials, shapes, relative positions and the like of components described in the embodiments shall be interpreted as illustrative only and not intended to limit the scope of the present invention. For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

(Configuration of Wind-Turbine Tower Facility)

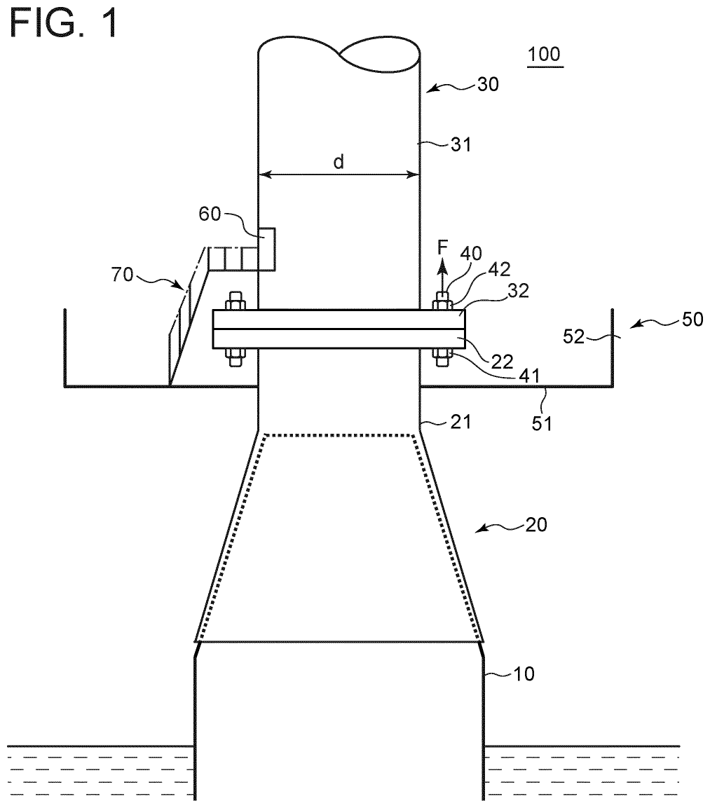

A configuration of a wind-turbine tower facility 100 according to an embodiment will now be described. FIG. 1 is a schematic diagram for describing the configuration of the wind-turbine tower facility 100 according to an embodiment. This figure shows the appearance of the wind-turbine tower facility 100. The wind-turbine tower facility 100 is a facility related to a wind turbine installed on the waterside, such as lakes, seas, and rivers.

As shown in FIG. 1, the wind-turbine tower facility 100 includes a foundation with a monopile 10 disposed in water such as on bottom of water (for example via a suction bucket or by insertion into the seabed), and a transition piece 20 disposed on top of the monopile 10. It should be noted that the expression “disposed on top of” encompass both embodiments where a two members are disposed face to face one over the other (typically via a flange connection) as well as embodiments where an end part of a first member is disposed with some vertical overlap to a second member (similar to for example a hat on a head or an egg in an egg cup). Furthermore, the wind-turbine tower facility 100 includes a tower 30 disposed on top of the transition piece 20. On top of the tower 30, a nacelle, a hub, a wind turbine blade, a generator, and the like (not shown) are disposed as components for generating wind power. The wind-turbine tower facility 100 may be a part of a wind turbine excluding components such as the nacelle, the hub, the wind turbine blade, the generator, and the like, or may be a wind turbine including these components.

The tower 30 includes a first cylindrical part 31 and a first outer flange 32 protruding from a lower end of the first cylindrical part 31 toward the outer side of the tower 30. The foundation, in FIG. 1 more specifically transition piece 20 includes a second cylindrical part 21 and a second outer flange 22 protruding from an upper end of the second cylindrical part 21 toward the outer side of the transition piece 20.

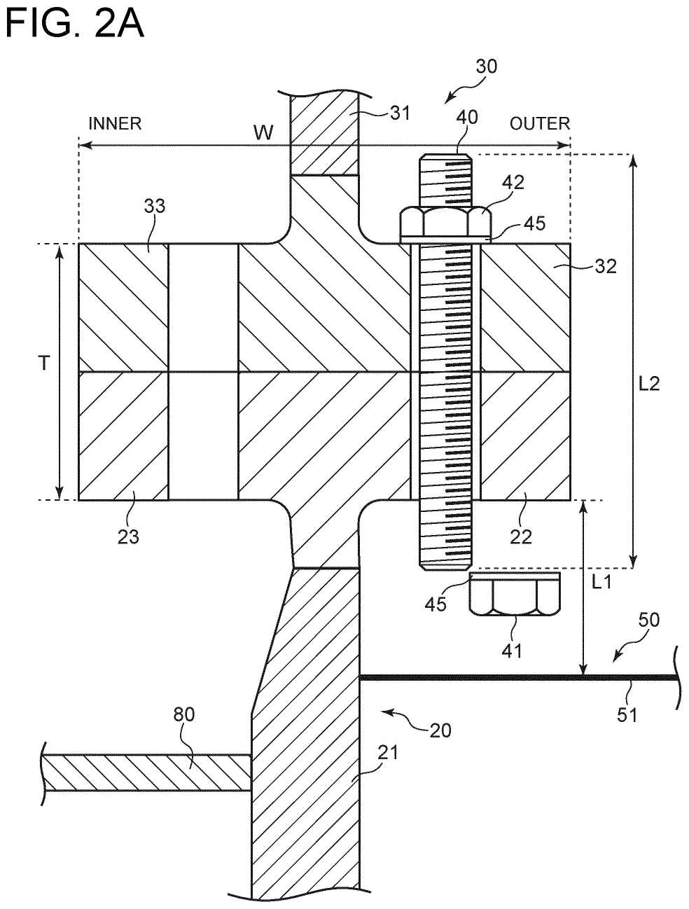

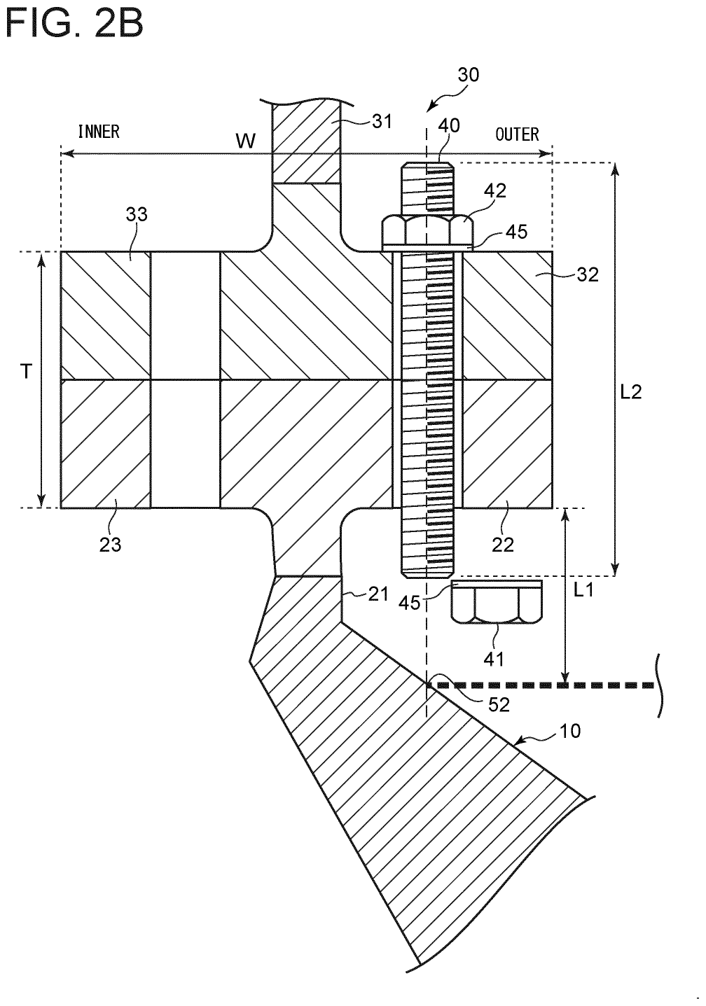

The tower 30 and the transition piece 20 are connected by a plurality of stud bolts passing through the first outer flange 32 and the second outer flange 22. A first nut 41 is disposed on the lower side of the stud bolt, and a second nut 42 is disposed on the upper side of the stud bolt. Since the bolt is a stud bolt, both nuts are releasably connected to the stud bolt. As shown in FIG. 2 described later, washers 45 may be disposed between the first nut 41 and the second outer flange 22 and between the second nut 42 and the first outer flange 32. Or a flange nut can be used.

A protruding part, in FIG. 1 exemplified by a platform 50 used for maintenance by an operator is disposed, below the second outer flange 22, on the outer periphery of the transition piece 20. The platform 50 includes a floor 51 and a handrail 52 disposed along the outer periphery of the transition piece 20. In FIG. 1, the platform 50 is simply illustrated in order to make it easy to see the connection portion between the tower 30 and the transition piece 20. The protruding part such as the platform 50 may cover the entire circumference of the transition piece 20, for instance. It is highly preferred that the protruding part is a platform, but examples of other advantageous embodiments of the invention concerns when the protruding part is a leg of the foundation for example of a tripod or a jacket foundation, or a tubular structure with an expanding diameter for example for a floating foundation.

It is preferred that the foundation of the wind-turbine tower facility comprises a base part selected from the group consisting of a monopile foundation, a jacket foundation, a tripod foundation, a gravity foundation and a floating foundation. Furthermore, the foundation may optionally further comprises a transition piece disposed on top of the base part. A particularly preferred type of foundation is a foundation that comprises a transition piece 20 disposed on top of a monopile 10, where the transition piece includes the second cylindrical part 21 and the platform 50 is disposed on an outer periphery of the transition piece 20.

The first cylindrical part 31 of the tower 30 has an entrance 60 allowing a person to get in and out of the tower 30. The entrance is above the first outer flange of the tower so to get from the flatform to the entrance stairs 70 are connecting the entrance 60 and the platform 50. Alternatively, a ladder may connect the entrance and the platform instead of the stairs 70. The stairs or ladder may be provided as a part of the tower, as part of the foundation (such as the transition piece) or as a separate part.

In the example shown in FIG. 1, the outer diameter of the second cylindrical part 21 of the transition piece 20 of the foundation may be enlarged at a lower part connected to the monopile 10 and preferably includes a larger outer diameter than the outer diameter of the second outer flange 22. Further, the outer diameter of the bottom of the transition piece 20 is preferably larger than the outer diameter of the second outer flange 22. Thereby, it is possible to improve the stability as the base. An upper part of the monopile 10 is inserted into the transition piece 20 as shown by the dotted line. A radial-directional clearance between the monopile 10 and the transition piece 20 may be filled with grout (not shown).

Here, as shown in FIG. 2, when W is the inner-to-outer flange width of the first outer flange 32 and the second outer flange 22, and T is the total flange thickness of the first outer flange 32 and the second outer flange 22, preferably 1<(W/T)<3. Further, when d_{bolt} is the diameter of the stud bolt 40, preferably 5×d_{bolt}<W<11×d_{bolt}. With this configuration, it is possible to provide enough strength even if the installation conditions are strict due to an external environment such as waves and wind. The inner-to-outer flange width W is the width from the outer edge of the first outer flange 32 or the second outer flange 22 to the inner wall surface of the second cylindrical part 21. For example, in the case that the first inner flange 33 is continuously formed from the first outer flange 32, the inner-to-outer flange width W of the first outer flange 32 includes the width of the first outer flange 32 and the width of the first inner flange 33. In contrast, in the case that the first inner flange 33 does not exist, the inner-to-outer flange width W of the first outer flange 32 does not include the width of the first inner flange 33. The inner-to-outer flange width W of the second outer flange 22 is similarly defined.

FIG. 2 is a cross-sectional view of a connection portion between the tower 30 and the transition piece 20 of a foundation according to an embodiment. This figure shows an enlarged vertical cross-section of the connection portion. As shown in FIG. 2, the tower 30 of this embodiment further includes a first inner flange 33 protruding from the lower end of the first cylindrical part 31 toward the inner side of the tower 30. The foundation further includes a second inner flange 23 protruding from the upper end of the second cylindrical part 21 toward the inner side of the foundation, here exemplified as the transition piece 20. The tower 30 and the foundation (such as the shown transition piece 20) are connected by a plurality of stud bolts 40 passing through the first inner flange 33 and the second inner flange 23.

Thus, the tower 30 and the foundation 10, 20 may be connected at the first outer flange 32 and the second outer flange 22, or may be connected at, in addition to the first outer flange 32 and the second outer flange 22, the first inner flange 33 and the second inner flange 23. In FIG. 2, the stud bolt 40 passing through the first inner flange 33 and the second inner flange 23 is not depicted, but the first inner flange 33 and the second inner flange 23 are secured with the stud bolt 40 in the same manner as the first outer flange 32 and the second outer flange 22.

The first inner flange 33 and the second inner flange 23 preferably have the same inner diameter and the same thickness. As a result, as shown in FIG. 2, it is possible to overlap the first inner flange 33 and second inner flange 23 so that their inner diameters are aligned.

The first outer flange 32 and the second outer flange 22 preferably have the same outer diameter and the same thickness. As a result, as shown in FIG. 2, it is possible to overlap the first outer flange 32 and second outer flange 22 so that their outer diameters are aligned.

The first outer flange 32 and the first inner flange 33 may be formed by a single annular member. That is, the first outer flange 32 and the first inner flange 33 may be integrally formed as a T-shaped flange. The same applies to the second outer flange 22 and the second inner flange 23. Further, as shown in FIG. 2, the first outer flange 32 and the first inner flange 33 may have the same inner-to-outer flange width W and the same thickness T/2, and the second outer flange 22 and the second inner flange 23 may have the same inner-to-outer flange width W and the same thickness T/2.

As shown in FIG. 2, a scaffold 80 may be disposed on the inner side of the foundation exemplified by the transition piece 20. Using the scaffold 80, the operator can secure the first inner flange 33 to the second inner flange 23. The scaffold 80 is preferably disposed in a range of 0.5 to 2 m from the second inner flange 23 so that the operator on the scaffold can reach the connection position.

It was found that the invention is particularly advantageous in an embodiment, where the protruding part protrudes more in a horizontal plane than the outer diameter of the outer flange, and a vertical distance L1 between an upper surface of the protruding part directly under stud bolt 40 connecting the first outer flange 32 and the second outer flange 22, and a lower surface of the second outer flange 22 is shorter than a length of the stud bolts L2 for at least one of the stud bolts 40 connecting the tower 30 and the foundation 10, 20.

As shown in FIG. 2A, a distance L1 between the upper surface of the protruding part exemplified by the floor 51 of the platform 50 and the lower surface of the second outer flange 22 may be shorter than a length L2 of the stud bolt 40. For instance, when L2 is 400 mm or less (e.g., 370 mm), L1 may be 350 mm or less (e.g., 220 mm). In this case, the protruding part (here the floor 51 of the platform 50) is positioned at a height close to the second outer flange 22. In FIG. 2B, the protruding part is exemplified by a leg (10) of the foundation. In FIG. 2B, the upper surface of the protruding part directly under stud bolt 40 is marked by 52 and the vertical distance L1 is also marked.

Flanges of wind turbine foundations and wind turbine towers are traditionally connected by typical bolts having one fixed head and one removable nut since such bolts are fast to secure and easy to handle.

For the situation described in FIG. 2, it was found to be highly advantageous to use stud bolts. Stud bolts are threaded pins (sometimes also referred to as double end threaded bolts) being threaded in the full length or at least in sections near both ends of the pin and equipped with removable nuts near both ends. This is for example due to that the distance L1 between the second outer flange and the protruding part can be much shorter than what can be realized using typical bolts where L1 typically would be more than 500 mm. If the protruding part is a platform and an entrance to the tower is placed above the first flange(s) 32 (33), then the use of stud bolts allows for a shorter stairs or ladder for connecting the entrance and the platform, which leads to savings on the materials (so cost and weight) and/or increases safety by reduces the impact of falling down the stairs. Furthermore, the flange 22,23,32,33 positions are much higher on the construction, hence these flange may require to be made stronger (and typically thicker) to keep strength when the installation conditions are strict due to an external environment such as waves and wind.

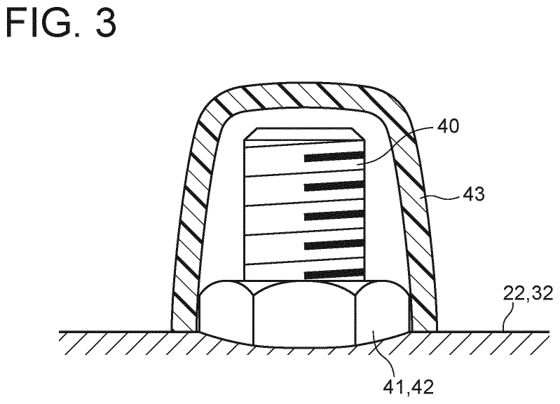

FIG. 3 is a cross-sectional view of a cap 43 disposed on the wind-turbine tower facility 100 according to an embodiment. As shown in FIG. 3, while the stud bolt 40 is inserted in the second outer flange 22 with a first nut 41, the cap 43 may be disposed so as to cover an exposed portion of the stud bolt 40 and the first nut 41. Similarly, while the stud bolt 40 is inserted in the first outer flange 32 with a second nut 42, the cap 43 may be disposed so as to cover an exposed portion of the stud bolt 40 and the second nut 42. Thus, by covering the exposed portion of the stud bolt 40 and the nut (first nut 41 and second nut 42) with the cap 43, it is possible to prevent corrosion at the exposed portion of the stud bolt and the nut.

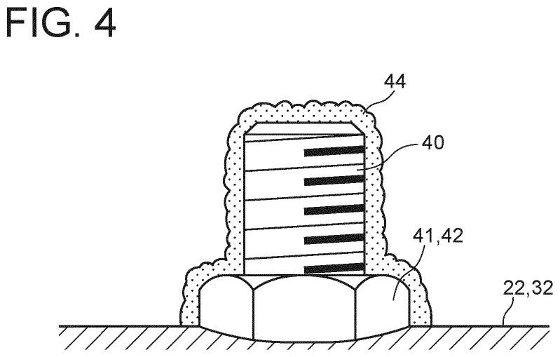

FIG. 4 is a cross-sectional view of a grease 44 used for the wind-turbine tower facility 100 according to an embodiment. As shown in FIG. 4, the grease 44 may be applied to the exposed portion of the stud bolt 40 and the nut (first nut 41 and second nut 42). Thus, it is possible to prevent corrosion at the exposed portion of the stud bolt 40 and the nut. After the grease 44 is applied, the cap 43 may be provided.

Incidentally, there can be a case where the inclination angle of the tower 30 is deviated from an acceptable range in terms of operation of the wind turbine when the tower is connected to the foundation. In this case, it is necessary to adjust the inclination angle of the tower 30.

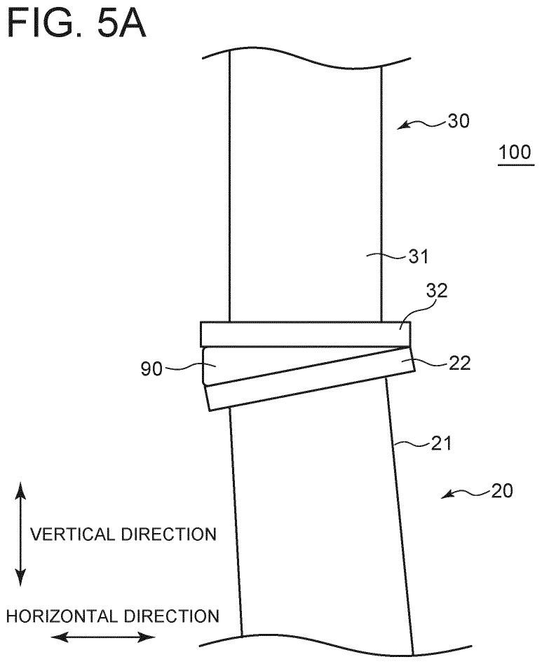

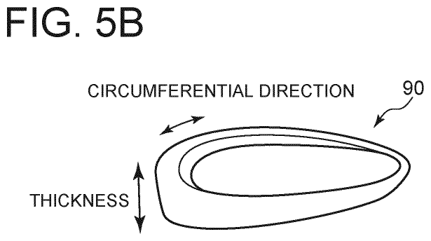

FIG. 5A is a front view of usage of an adjustment ring 90 of the wind-turbine tower facility 100 according to an embodiment. The components such as the stud bolt 40 are not depicted in this figure. FIG. 5B is a perspective view of the adjustment ring 90 provided in the wind-turbine tower facility 100 according to an embodiment.

As shown in FIG. 5A, the adjustment ring 90 disposed between the tower 30 and the foundation exemplified by the transition piece 20 makes it possible to bring the inclination angle of the tower 30 into an acceptable range in terms of operation of the wind turbine. For instance, in FIG. 5A, the transition piece 20 is inclined with respect to the vertical direction, and the upper surface of the transition piece 20 is not horizontal. Even in this case, the lower surface of the tower 30 can be adjusted to be horizontal by the adjustment ring 90.

As shown in FIG. 5B, the thickness of the adjustment ring 90 is uneven in the circumferential direction. In other words, the cross-sectional shape of the adjustment ring 90 varies with position in the circumferential direction. The adjustment ring 90 preferably has the same outer diameter as the first outer flange 32 and the second outer flange 22. The adjustment ring 90 preferably has the same inner diameter as the first inner flange 33 and the second inner flange 23.

If a single adjustment ring 90 is not enough for adjustment, multiple adjustment rings 90 may be combined for adjustment. For instance, a 1-mm thick adjustment ring 90 may be combined with a 3-mm thick adjustment ring 90 for adjustment of 4 mm thickness. Thus, the inclination angle of the tower 30 can be adjusted by one or more adjustment rings 90. The adjustment ring 90 may be a single piece full ring or the ring may consist of a number of smaller sections, such as 2, 4, 10 or another number of sections up to about 20 sections. This allows for easier manufacturing, transportation and installation of the adjustment ring, particularly for towers with a diameter of more than 7 meters.

(Method of Assembling Wind-Turbine Tower Facility)

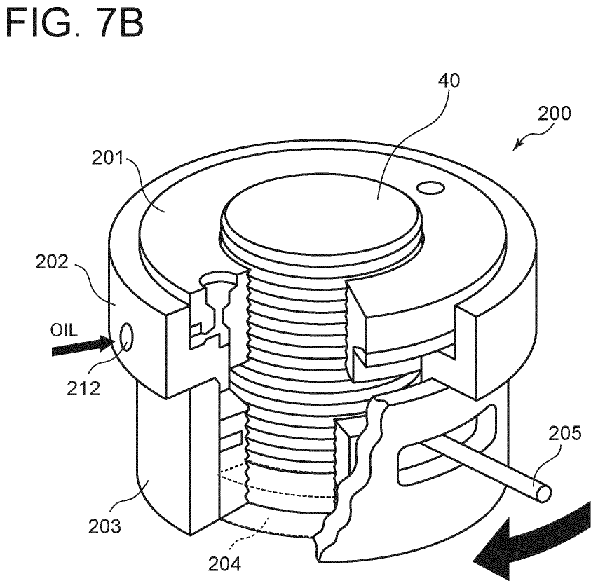

A method of assembling the wind-turbine tower facility 100 according to an embodiment will now be described. The method of assembling the wind-turbine tower facility 100 means a method of producing the wind-turbine tower facility 100. Here, connection operation using a bolt tensioner device 200 (see FIG. 7A or 7B described later) will be described as an example.

In this example, for preparation before assembly, a first annular member is welded to the lower end of the first cylindrical part 31 of the tower 30 to form the first outer flange 32 and the first inner flange 33. Further, a second annular member is welded to the upper end of the second cylindrical part 21 of the foundation to form the second outer flange 22 and the second inner flange 23. In this case, for instance, as shown in FIG. 2, the first outer flange 32 and the first inner flange 33 are integrally formed, and the second outer flange 22 and the second inner flange 23 are integrally formed. Further, welding improves the strength of the connection portion. These steps may be incorporated as steps of the method of assembling the wind-turbine tower facility 100.

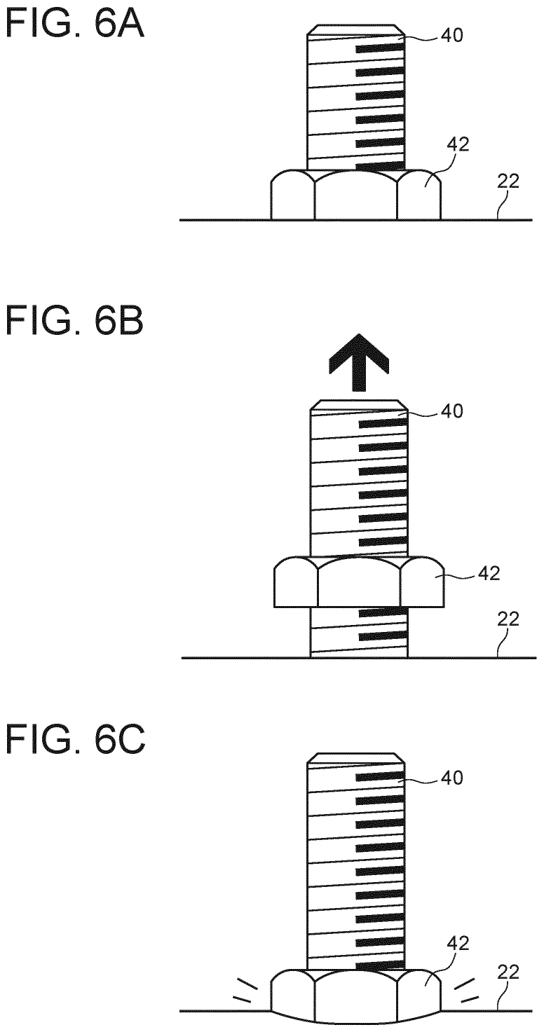

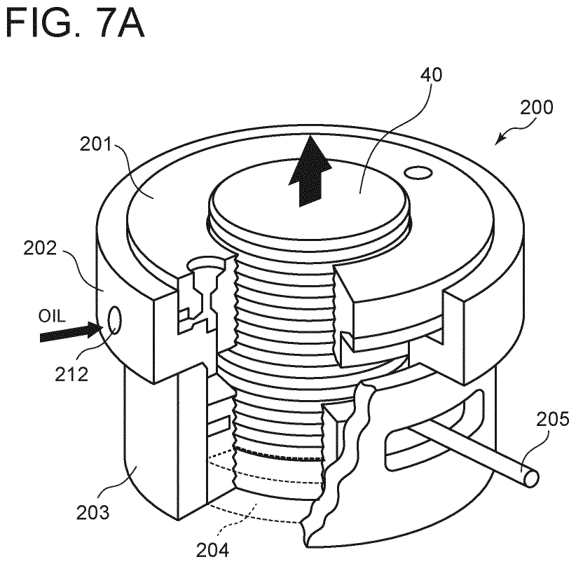

FIG. 6A is a schematic diagram showing a state where a nut (first nut 41 or second nut 42) is temporarily fixed to the stud bolt 40 according to an embodiment. FIG. 6B is a schematic diagram showing a state where the stud bolt 40 is tensioned according to an embodiment. FIG. 6C is a schematic diagram showing a state where the stud bolt 40 is tightened according to an embodiment.

FIG. 7A is a schematic diagram for describing a state where the bolt tensioner device 200 is about to be used according to an embodiment. FIG. 7B is a schematic diagram for describing a state where the bolt tensioner device 200 is being used according to an embodiment.

As shown in FIGS. 7A and 7B, the bolt tensioner device 200 includes a puller (sleeve) 201 disposed at an upper part, a body 202 for lifting the puller 201 by oil pressure, a bridge 203 disposed at a lower part, a nut ring 204 configured to be fitted to a nut to be tightened within the bridge 203, and a tommy bar 205 configured to rotate the nut via the nut ring 204. The body 202 includes a piston, a load cell, and a seal member, and further includes a hole 212 through which oil is supplied from a hydraulic pump (not shown). In FIGS. 7A and 7B, a part of configuration (for instance, bridge 203 and nut ring 204) is cut for illustrating the internal state.

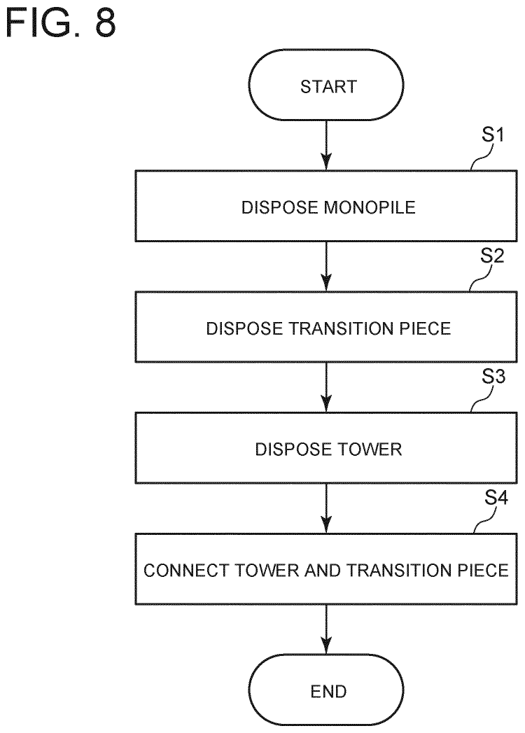

FIG. 8 is a flowchart of the method of assembling the wind-turbine tower facility 100 according to an embodiment where the foundation comprises a monopile and a transition piece, and the protruding part is a platform. The method of assembling the wind-turbine tower facility 100 according to an embodiment will be described with reference to FIG. 8.

Firstly, the monopile 10 is disposed on the bottom of water (step S1). Secondly, the transition piece 20 is disposed on top of the monopile 10 (step S2). The platform 50 is positioned, below the second outer flange 22, on the outer periphery of the transition piece 20.

The tower 30 is disposed on top of the transition piece 20 (step S3). The tower and the transition piece 20 are connected with the stud bolt 40 (step S4). The details of step S4 will be described specifically. For embodiments where the foundation base part is of another type than monopile, then step S1 is adjusted to that the used foundation base part, specifically, a jacket foundation, a tripod foundation, a gravity foundation or a floating foundation. For embodiments where the foundation does not comprise a transition piece, then step S2 is omitted and the tower is disposed directly on the foundation base part.

The stud bolt 40 is inserted from the upper side of the first outer flange 32 so as to pass through the first outer flange 32 and the second outer flange 22. By using the bolt tensioner device 200 on the outer side of the tower 30, tension is applied to the stud bolt 40 inserted through the first outer flange 32 and the second outer flange 22.

More specifically, the bolt tensioner device 200 is placed at the first outer flange 32, and the stud bolt 40 (optionally previously arranged through the flanges with the second nut 42 positioned near an upper end of the stud bolt 40) is held by the bolt tensioner device 200. Thus, the stud bolt 40 is fixed. In this state, the first nut 41 is screwed on the lower side of the stud bolt 40 from below the second outer flange 22.

Then, as shown in FIG. 6A, the second nut 42 is screwed from the upper side of the stud bolt 40. In this state, the second nut 42 is in temporarily fixed state. In FIGS. 6A to 6C, the bolt tensioner device 200 is not depicted.

Then, as shown in FIG. 6B and FIG. 7A, the stud bolt 40 is tensioned by the bolt tensioner device 200 in a direction shown by the arrow (i.e., upward). The tension is caused by supply of oil from the hydraulic pump. At this time, the temporarily fixed second nut 42 moves upward together with the stud bolt 40, and a gap is formed between the second nut 42 and the upper surface of the second outer flange 22. As shown in FIG. 7B, the second nut is rotated and tightened by the tommy bar 205 until the gap is eliminated.

This operation may be repeatedly performed. Then, after the bolt length or the axial force of the stud bolt 40 reaches a standard value, or the oil pressure of the bolt tensioner device 200 reaches a standard value, the second nut 42 is tightened on the upper end of the stud bolt 40. Thereafter, the tension applied to the stud bolt 40 by the bolt tensioner device 200 is released. Thus, as shown in FIG. 6C, the second nut 42 is finally tightened, and the stud bolt 40 is in a tightened state.

By performing this operation for each of the stud bolts 40, the tower 30 and the transition piece 20 are secured at the outer position.

Further, a plurality of stud bolts 40 are inserted so as to pass through the first inner flange 33 and the second inner flange 23. By using the bolt tensioner device 200 on the inner side of the tower 30 or the transition piece 20, tension is applied to the stud bolt 40 inserted in the first inner flange 33 and the second inner flange 23. More specifically, the stud bolt 40 is held by the bolt tensioner device 200, and the first nut 41 and the second nut 42 are attached thereto as described above.

By performing this operation for each of the stud bolts 40, the tower 30 and the transition piece 20 are secured at the inner position.

In this manner, by securing the tower 30 and the transition piece 20 at both the outer and inner sides, the connection strength is improved. Either the inner securing or the outer securing may be performed first. Further, in step S4, the grease 44 may be applied to the nut (first nut 41, second nut 42) and the stud bolt 40, and/or the cap 43 may be provided to cover the nut and the stud bolt 40. In this case, corrosion is reduced. Further, in step S4, the inclination angle of the tower 30 may be adjusted by one or more adjustment rings 90 having uneven thickness in the circumferential direction being secured below the tower. In practice, the adjustment ring(s) is arranged before step S3 where the tower is disposed before the adjustment ring(s) being secured in step S4. This makes it possible to bring the inclination angle of the tower 30 into an acceptable range in terms of operation of the wind turbine, for instance.

The present disclosure is not limited to the embodiments described above, but includes modifications to the embodiments described above, and embodiments composed of combinations of those embodiments.

(Conclusion)

The contents described in the above embodiments would be understood as follows, for instance.

(1) A wind-turbine tower facility (100) according to an embodiment of the present disclosure includes: a foundation (10,20); and a tower (30) disposed on top of the foundation (10,20). The tower (30) includes a first cylindrical part (31) and a first outer flange (32) protruding from a lower end of the first cylindrical part (31) toward an outer side of the tower (30). The foundation (10,20) includes a second cylindrical part (21) and a second outer flange (22) protruding from an upper end of the second cylindrical part (21) toward an outer side of the foundation (10,20). The tower (30) and the foundation (10,20) are connected by a plurality of bolts (40) passing through the first outer flange (32) and the second outer flange. Below the second outer flange (32), a protruding part (50) is protruding from the second cylindrical part (21) to under the second outer flange (32), and the plurality of bolts (40) are stud bolts (40).

The protruding part such a leg, a tubular structure with an expanding diameter or a platform may be arranged on the foundation to facilitate access to the tower (for example when the protruding part is a platform), to ensure a good balance (for example for a floating foundation) or a safe connection to the seabed (for example for a jacket or tripod foundation). The connection of the two outer flanges can be made in several ways including the traditional using a typical bolt having one fixed head and one removable nut where the typical tools and operation procedures may be used. In the traditional way, the first outer flange (32) of the tower (30) and the second outer flange (22) of the foundation (20) are secured with a typical bolt, the operator typically insert the bolt from below the second outer flange (22) so as to pass through the first outer flange (32) and the second outer flange and tighten the second nut (42) on the upper side of the flanges. Therefore, a certain space is required between the second outer flange (22) and the protruding part (50).

In this regard, with the above configuration (1), since the first outer flange (32) and the second outer flange (22) are secured by a plurality of stud bolts (40), it is possible to have the protrusion (50) closer to the second outer flange (22) compared with the case of using a typical bolt. It was found that this may lead to savings on materials with regard to cost or weight. Additionally, with the above configuration (1), since the first outer flange (32) and the second outer flange (22) are secured, it is possible to more firmly connect the tower (30) to the foundation (10,20), compared with the case where (only) inner flanges (e.g., first inner flange 33 and second inner flange 23) are secured.

(2) In some embodiments, in the above configuration (1), the protruding part (50) is a platform (50).

With the above configuration (2), the provision of the platform allows for example for a safe support to install the bolts and/or a place to (temporarily) store components and equipment to be used during installation or maintenance of the wind turbine tower facility.

(4) A wind-turbine tower facility (100) according to an embodiment of the present disclosure (which may be in the above configuration (2)) includes: a monopile (10); a transition piece (20) disposed on top of the monopile (10); and a tower (30) disposed on top of the transition piece (20). The tower (30) includes a first cylindrical part (31) and a first outer flange (32) protruding from a lower end of the first cylindrical part (31) toward an outer side of the tower (30). The transition piece (20) includes a second cylindrical part (21) and a second outer flange (22) protruding from an upper end of the second cylindrical part (21) toward an outer side of the transition piece (20). The tower (30) and the transition piece (20) are connected by a plurality of stud bolts (40) passing through the first outer flange (32) and the second outer flange (22). A platform (50) is disposed, below the second outer flange (22), on an outer periphery of the transition piece (20).

Generally, the height of the platform (50) needs to be higher than an expected maximum wave height by a predetermined distance and lower than the lower end of a wind turbine blade that faces just downward by a predetermined distance (e.g., 6 m). Further, generally, the entrance (60) allowing one to get in and out of the tower (3) is disposed on a side surface (first cylindrical part (31)) of the tower (30) at a position higher than the connection portion between the transition piece (20) and the tower (30) by a predetermined distance (e.g., 1 m) to prevent buckling.

The platform (50) is preferably disposed at a height that does not impair the accessibility to the entrance (60) of the tower (30) disposed in such a position. Taking into consideration these conditions, the platform (50) is disposed lower than the first outer flange (32) and the second outer flange (22) for connecting the tower (30) to the foundation (20) and preferably close to the second outer flange (22), on the outer periphery of the transition piece (20).

The connection of the two outer flanges can be made in several ways including the traditional using a typical bolt having one fixed head and one removable nut where the typical tools and operation procedures may be used. In the traditional way, the first outer flange (32) of the tower (30) and the second outer flange (22) of the transition piece (20) are secured with a typical bolt, the operator needs to insert the bolt from the platform (50) side, i.e., from the lower side of the second outer flange (22) so as to pass through the first outer flange (32) and the second outer flange and tighten the second nut (42) on the upper side of the flanges. Therefore, a certain space is required between the second outer flange (22) and the platform (50).

In this regard, with the above configuration (4), since the first outer flange (32) and the second outer flange (22) are secured by a plurality of stud bolts (40), it is possible to dispose the platform (50) closer to the second outer flange (22) compared with the case of using a typical bolt. It was found that this may allow for a more safe entrance to the tower from the platform and/or may lead to savings on materials with regard to cost or weight. Additionally, with the above configuration (4), since the first outer flange (32) and the second outer flange (22) are secured, it is possible to more firmly connect the tower (30) to the transition piece (20), compared with the case where (only) inner flanges (e.g., first inner flange 33 and second inner flange 23) are secured.

(5) In some embodiments, in any one of the above configurations (2) to (4), the first cylindrical part (31) of the tower (30) has an entrance (60) allowing a person to get in and out of the tower (30), and stairs (70) or a ladder are connecting the entrance (60) and the platform (50).

With the above configuration (5), the provision of the stairs (60) or a ladder connecting the entrance (60) and the platform (50) improves the accessibility. Further, as the platform (50) is positioned closer to the second outer flange (22) with the above configuration (1), the length of the stairs (70) or the ladder is shortened, which may reduce cost of stairs and other parts like transition piece crane (if present), improve accessibility and/or improve safety by reducing the impact in the unlikely event of falling down the stairs.

(6) In some embodiments, in any one of the above configuration (1) to (5), the tower (30) includes a first inner flange (33) protruding from the lower end of the first cylindrical part (31) toward an inner side of the tower (30), the foundation (for example a transition piece (20) of the foundation) includes a second inner flange (23) protruding from the upper end of the second cylindrical part (21) toward an inner side of the foundation (20), and the tower (30) and foundation (20) are connected by a plurality of the stud bolts (40) passing through the first inner flange (33) and the second inner flange (23).

With the above configuration (6), since the tower (30) and the foundation (20) are secured at both the outer and inner sides, the connection strength is improved.

(6A) In some embodiments, in the above configuration (6), the first inner flange (33) of the tower (30) and the second inner flange (23) of the foundation (20) have the same inner diameter and the same thickness.

With the above configuration (6A), it is possible to overlap and align the inner diameters. Thus, connection strength is improved.

(6B) In some embodiments, in any one of the above configurations (1) to (6A), the first outer flange (32) of the tower (30) and the second outer flange (22) of the foundation (20) have the same outer diameter and the same thickness.

With the above configuration (6B), it is possible to overlap and align the outer diameters. Thus, connection strength is improved.

(7) In some embodiments, in any one of the above configurations (1) to (6B), the protruding part protrudes more in a horizontal plane than the outer diameter of the outer flange. Furthermore, a vertical distance between an upper surface of the protruding part and a lower surface of the second outer flange is shorter than a length of the stud bolts for at least one of the stud bolts connecting the tower and the foundation.

As described in the above configuration (1), since the stud bolt (40) is used, a space for inserting the heavy bolt from the platform (50) side so as to pass through the first outer flange (32) and the second outer flange (22) is not necessary. As a result, the above configuration (7) can be adopted, so that it is possible to decrease the distance between the protruding part (50) and the second outer flange (22) to a very low distance.

(8) In some embodiments, in any one of the above configurations (2) to (7), a distance between an upper surface of the platform (50) and the lower surface of the second outer flange (22) is shorter than a length of each of the stud bolts (40).

As described in the above configuration (1), since the stud bolt (40) is used, a space for inserting the heavy bolt from the platform (50) side so as to pass through the first outer flange (32) and the second outer flange (22) is not necessary. As a result, the above configuration (6) can be adopted, so that it is possible to sufficiently decrease the distance between the platform (50) and the second outer flange (22).

(8A) In some embodiments, in any one of the above configurations (1) to (8), one or more adjustment rings (90) of uneven thickness in a circumferential direction are disposed between the tower (30) and the transition piece (20).

With the above configuration (8A), it is possible to bring the inclination angle of the tower (30) into an acceptable range in terms of operation of the wind turbine.

(9) In some embodiments, in any one of the above configurations (1) to (8A), 1<(W/T)<3, where W is an inner-to-outer flange width of the first outer flange (32) and the second outer flange (22), and T is a total flange thickness of the first outer flange (32) and the second outer flange (22), and 5×d_{bolt}<W<11×d_{bolt}, where d_{bolt} is a diameter of each of the stud bolts (40).

With the above configuration (9), it is possible to provide enough strength even if the installation conditions are strict due to an external environment such as waves and wind.

(9A) In some embodiments, in any one of the above configurations (1) to (9), the wind-turbine tower facility includes a nut (41, 42) disposed on each of the stud bolts (40); and a cap (43) covering an exposed portion of the stud bolt (40) and the nut (41, 42).

With the above configuration (9A), by covering the exposed portion of the stud bolt (40) and the nut (first nut 41 and second nut 42) with the cap (43), it is possible to prevent corrosion at the exposed portion of the stud bolt (40) and the nut.

(10) A method of assembling a wind-turbine tower facility (100) according to an embodiment of the present disclosure includes: disposing a foundation (10,20) in water; and disposing a tower (30) on top of the foundation (10,20). Inserting a plurality of bolts (40) so as to pass through a first outer flange (32) protruding from a lower end of a first cylindrical part (31) of the tower (30) toward an outer side of the tower (30) and a second outer flange (22) protruding from an upper end of a second cylindrical part (21) of the foundation (10,20) toward an outer side of the foundation (10,20) to connect the tower (30) and the foundation (10,20) by the plurality of bolts (40). Below the second outer flange (22), a protruding part (50) is protruding from the second cylindrical part (21) to under the second outer flange part (22), and the plurality of bolts (40) are stud bolts (40).

With the above method (10), it is possible to provide a wind-turbine tower facility (100) that can more firmly connect the tower (30) to the transition piece (20) and can place the platform (50) in an appropriate position.

(11) In some embodiments, in the above configuration (10), the protruding part (50) is a platform (50).

With the above configuration (11), the provision of the platform allows for example for a safe support to install the bolts (40) and/or a place to (temporarily) store components and equipment to be used during installation or maintenance of the wind turbine tower facility (100)

(12) In some embodiments, in the above configuration (11), disposing a foundation (10,20) in water includes disposing a monopile (10) on bottom of water and disposing a transition piece (20) on top of the monopile (10). The transition piece (20) includes the second cylindrical part (21) and the platform (50) is disposed on an outer periphery of the transition piece (20).

With the above configuration (12), it was found that a wind turbine tower facility could be realized, which facility may allow for a more safe entrance to the tower from the platform and/or may lead to savings on materials with regard to cost or weight. (12A) In some embodiments, in the above method (10) or (11), the method includes applying tension to the stud bolts (40) inserted through the first outer flange (32) and the second outer flange (22) by using a bolt tensioner device (200) on the outer side of the tower (30).

With the above method (12A), for instance, the flanges can be secured by inserting the stud bolt (40) from above and tightening the second nut (42) while pulling up the stud bolt (40) by tension applied by the bolt tensioner device (200) thereon. The first nut (41) may be fixed to be prevented from moving before inserting the stud bolt (40), and may be tightened from below after inserting the stud bolt (40). Accordingly, it is possible to reduce the burden of the operator.

(13) In some embodiments, in any one of the above methods (10) to (12), the method includes inserting a plurality of the stud bolts (40) so as to pass through a first inner flange (33) protruding from the lower end of the first cylindrical part (31) of the tower (30) toward an inner side of the tower (30) and a second inner flange (23) protruding from the upper end of the second cylindrical part (21) of the transition piece (20) toward an inner side of the transition piece (20) to connect the tower (30) and the transition piece (20) by the plurality of stud bolts (40).

With the above method (13), since the tower (30) and the transition piece (20) are secured at both the outer and inner sides, the connection strength is improved.

(13A) In some embodiments, in the above method (12), the method includes applying tension to the stud bolts (40) inserted through the first inner flange (33) and the second inner flange (23) by using a bolt tensioner device (200) on the inner side of the tower (30) or the transition piece (20).

With the above method (13A), by using the bolt tensioner device (200) for tightening the bolt, it is possible to reduce the burden of the operator.

(14) In some embodiments, in any one of the above methods (10) to (13), the method includes: attaching each of the stud bolts (40) from an upper side of the first outer flange (32) so as to pass through the first outer flange (32) and the second outer flange (22) and fixing the stud bolt (40); placing a bolt tensioner device (200) at the first outer flange (32) and holding the stud bolt (40) by the bolt tensioner device (200); screwing a first nut (41) on a lower side of the stud bolt (40), then applying tension to the stud bolt (40) by the bolt tensioner device (200), and thereafter tightening a second nut (42) on an upper side of the stud bolt (40); and releasing the tension applied to the stud bolt (40) by the bolt tensioner device (200).

With the above method (14), it is possible to reduce the burden of the operator when tightening the bolt. For instance, the operator can use the platform (50) or the scaffold (80) disposed on the inner side of the transition piece (20) for bolt tightening operation.

(14A) In some embodiments, in any one of the above methods (10) to (14), the method includes adjusting an inclination angle of the tower (30) by one or more adjustment ring (90) of uneven thickness in a circumferential direction.

With the above method (14A), it is possible to bring the inclination angle of the tower (30) into an acceptable range in terms of operation of the wind turbine, for instance.

1. A wind-turbine tower facility comprising:
a foundation; and
a tower disposed on top of the foundation,
wherein the tower includes a first cylindrical part and a first outer flange protruding from a lower end of the first cylindrical part toward an outer side of the tower,
wherein the foundation includes a second cylindrical part and a second outer flange protruding from an upper end of the second cylindrical part toward an outer side of the foundation,
wherein the tower and the foundation are connected by a plurality of bolts passing through the first outer flange and the second outer flange,
wherein below the second outer flange, a protruding part is protruding from the second cylindrical part to under the second outer flange, and
wherein the plurality of bolts are stud bolts.

2. The wind-turbine tower facility according to claim 1,
wherein the protruding part is a platform.

3. The wind-turbine tower facility according to claim 1,
wherein the foundation comprises a base part selected from the group consisting of a monopile foundation, a jacket foundation, a tripod foundation, a gravity foundation and a floating foundation; and
the foundation optionally further comprises a transition piece disposed on top of the base part.

4. The wind-turbine tower facility according to claim 2,
wherein the foundation comprises a transition piece disposed on top of a monopile, the transition piece includes the second cylindrical part and the platform is disposed on an outer periphery of the transition piece.

5. The wind-turbine tower facility according to claim 2,
wherein the first cylindrical part of the tower has an entrance allowing a person to get in and out of the tower, and
wherein stairs or a ladder are connecting the entrance and the platform.

6. The wind-turbine tower facility according to claim 1,
wherein the tower includes a first inner flange protruding from the lower end of the first cylindrical part toward an inner side of the tower,
wherein the foundation includes a second inner flange protruding from the upper end of the second cylindrical part toward an inner side of the foundation, and
wherein the tower and foundation are connected by a plurality of the bolts passing through the first inner flange and the second inner flange, and wherein the plurality of bolts are stud bolts.

7. The wind-turbine tower facility according to claim 1,
wherein the protruding part protrudes more in a horizontal plane than the outer diameter of the outer flange and a vertical distance between an upper surface of the protruding part and a lower surface of the second outer flange is shorter than a length of the stud bolts for at least one of the stud bolts connecting the tower and the foundation.

8. The wind-turbine tower facility according to claim 2,
wherein a distance between an upper surface of the platform and the lower surface of the second outer flange is shorter than a length of each of the stud bolts.

9. The wind-turbine tower facility according to claim 1,
wherein 1<(W/T)<3, where W is an inner-to-outer flange width of the first outer flange and the second outer flange, and T is a total flange thickness of the first outer flange and the second outer flange, and
wherein 5×d_{bolt}<W<11×d_{bolt}, where d_{bolt} is a diameter of each of the stud bolts.

10. A method of assembling a wind-turbine tower facility comprising:
disposing a foundation in water;
disposing a tower on top of the foundation; and
inserting a plurality of bolts so as to pass through a first outer flange protruding from a lower end of a first cylindrical part of the tower toward an outer side of the tower and a second outer flange protruding from an upper end of a second cylindrical part of the foundation toward an outer side of the foundation to connect the tower and the foundation by the plurality of bolts,
wherein below the second outer flange, a protruding part is protruding from the second cylindrical part to under the second outer flange part, and
wherein the plurality of bolts are stud bolts.

11. The method of assembling a wind-turbine tower facility according to claim 10, wherein the protruding part is a platform.

12. The method of assembling a wind-turbine tower facility according to claim 11, wherein disposing a foundation in water comprising disposing a monopile on bottom of water and disposing a transition piece on top of the monopile, the transition piece includes the second cylindrical part and the platform is disposed on an outer periphery of the transition piece.

13. The method of assembling a wind-turbine tower facility according to claim 10, comprising inserting a plurality of the stud bolts so as to pass through a first inner flange protruding from the lower end of the first cylindrical part of the tower toward an inner side of the tower and a second inner flange protruding from the upper end of the second cylindrical part of the transition piece toward an inner side of the transition piece to connect the tower and the transition piece by the plurality of stud bolts.

14. The method of assembling a wind-turbine tower facility according to claim 10, comprising:
attaching each of the stud bolts from an upper side of the first outer flange so as to pass through the first outer flange and the second outer flange and fixing the stud bolt;
placing a bolt tensioner device at the first outer flange and holding the stud bolt by the bolt tensioner device;
screwing a first nut on a lower side of the stud bolt, then applying tension to the stud bolt by the bolt tensioner device, and thereafter tightening a second nut on an upper side of the stud bolt; and
releasing the tension applied to the stud bolt by the bolt tensioner device.
